(19) United States
(12) Patent Application Publication
(10) Pub. No.: US 2015/0100321 A1
(43) Pub. Date: Apr. 9, 2015

(54) INTELLIGENT STATE AWARE SYSTEM CONTROL UTILIZING TWO-WAY VOICE / AUDIO COMMUNICATION

(71) Applicant: Naviscent, LLC, San Carlos, CA (US)

(72) Inventors: George A. Papazian, San Carlos, CA (US); Alex Koorkoff, Murphys, CA (US); Sheryl K. Olguin, Cocoa, FL (US)

(73) Assignee: Naviscent, LLC, San Carlos, CA (US)

(21) Appl. No.: 14/048,441

(22) Filed: Oct. 8, 2013

(51) Int. Cl. G10L 21/06

(52) U.S. Cl. CPC G10L 21/06
USPC 704/275

(57) ABSTRACT

The embodiments provide a method and system for enabling an intelligent state aware system control utilizing two-way voice/audio communication using an electronic device. The method includes receiving voice commands from a user and identifying one or more actions associated with the voice command. Further, the method includes maintaining internal states of the actions based on one or more rules, where the internal states are dynamically defined based on a response to the voice command and the action. Further, the method includes computing application commands by performing the actions in accordance to the internal state, and providing a voice response to the user from the electronic device in response to execution of the application commands on corresponding applications.

### TECHNICAL FIELD

The embodiments herein relate to voice-enabled computer or device communication and, more particularly, to a mechanism for performing two-way voice-enabled system control by dynamically maintaining internal states of the system.

### BACKGROUND

Voice-enabled computer or device communication systems have been available and in use for many years. These systems typically incorporate a combination of computer hardware and software resident on an electronic device to allow a user to control the device by recitation of oral commands. The oral commands are then converted into executable commands, which can control or perform various actions on the electronic device. Generally, the voice-enabled communication systems that drive voice controlled devices can be found in various types of technology ranging from computer interfaces, automobiles, cellular telephones, and other handheld or wearable devices.

Conventional wireless communication devices depend on programming that resides entirely on the device. The technology relies on the device-based voice interfaces which may or may not interact directly with applications on the wireless communication. Further, the applications may not necessarily have access or control the voice interface in a way that enables tight integration with prompts, commands, queries, and responses. As a result, many applications that could benefit from use in hands-free or eyes-free scenarios are not capable of being used hands-free or eyes-free. Accordingly, it is desired to have a two-way voice-enabled communication that offers a voice based experience for various applications that would benefit from hands-free and eyes-free.

### BRIEF DESCRIPTION OF THE FIGURES

The embodiments herein will be better understood from the following detailed description with reference to the drawings, in which:

FIG. 1 illustrates generally, among other things, a high level overview of an intelligent state aware system control utilizing two-way voice (or audio) communication, according to embodiments disclosed herein

FIG. 2 illustrates different modules present in electronic device, according to embodiments as disclosed herein;

FIG. 3 illustrates a flow diagram illustrating a method for enabling two-way voice communication using the electronic device, according to embodiments as disclosed herein; and

FIG. 4 is a computing environment implementing the system and method, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein disclose a system and method for enabling state aware system control utilizing two-way voice/audio communication. In an embodiment, the method includes receiving voice commands indicating one or more actions to be performed on an electronic device or remote sources. The electronic device can be configured to maintain one or more internal states of the actions based on one or more rules to accurately perform the actions throughout the system. Unlike, conventional systems, the internal states can be dynamically defined based on for example, but not limited to, a response to the voice commands, and a response of execution of the actions. One or more application commands can be computed by performing the actions in accordance to the internal states. The application command described herein includes an instruction that causes corresponding applications residing on the electronic device or on the remote sources to execute the application commands. Further, a voice response is provided to the user in response to execution of the application commands.

The proposed system and method is simple, reliable, and robust for performing two-way voice-enabled communication by maintaining the internal states using intelligent rule engine. The system and method can be used to allow the applications on the election devices to access or control the voice interface in a way that enables tight integration with prompts, commands, queries, and responses. The use of the two-way voice-enabled communication, by maintaining the internal states, offers a voice based experience to the users to use various applications hands-free and eyes-free. Furthermore, the proposed system and method can be implemented on the existing infrastructure and may not require extensive set-up or instrumentation.

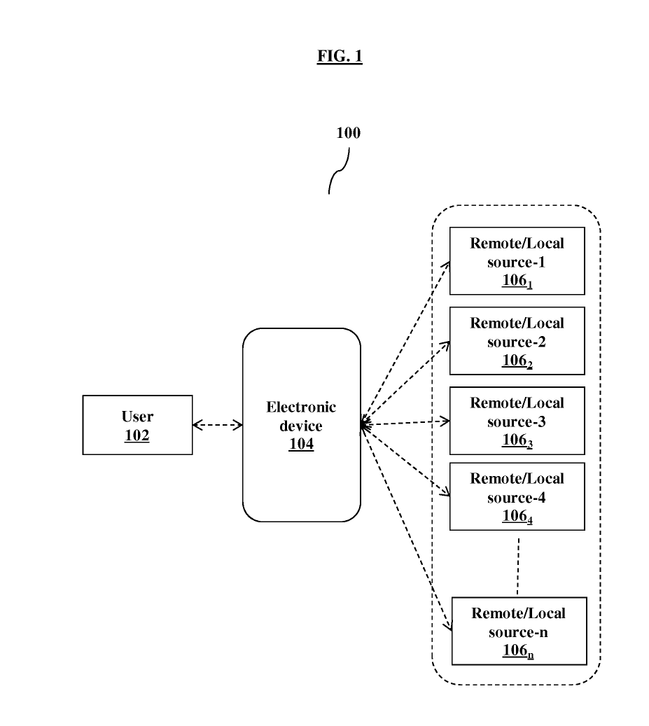

Referring now to the drawings, and more particularly to FIGS. 1 through 4, where similar reference characters denote corresponding features consistently throughout the figures, there are shown embodiments.

FIG. 1 illustrates generally, among other things, a high level overview of an intelligent state aware system 100, according to embodiments disclosed herein. The system 100 includes a user 102 communicating with an electronic device 104 by recitation of voice commands. The electronic device 104 described herein can be for example, but not limited to, a telephone, a wireless communicator, a tablet computer, a laptop computer, a personal digital assistant, a desktop computer, a processor with memory, a kiosk, a consumer electronic device, a consumer entertainment device, a smart phone, a music player, a camera, a television, an electronic gaming unit, a computing device, a mobile device, a wearable computer, or the like. The electronic device 104 also has an audio recording capability, such as a microphone, which can record voice commands received from the user 102 in the form of audio data. The electronic device 104 can be configured to include or implement at least a portion of the intelligent two-way voice-enabled computer or device communication interface, features, functionalities, or application disclosed herein. The user of the electronic device 104 accesses a voice-command interface, which may be installed or resident on the electronic device 104, and speaks a command to perform one or more action on the electronic device 104 or remote sources 106 into the device's microphone. The electronic device 104 records the voice command and creates a recorded voice command file. Optionally, the electronic device 104 can store the recorded voice command file internally for future use.

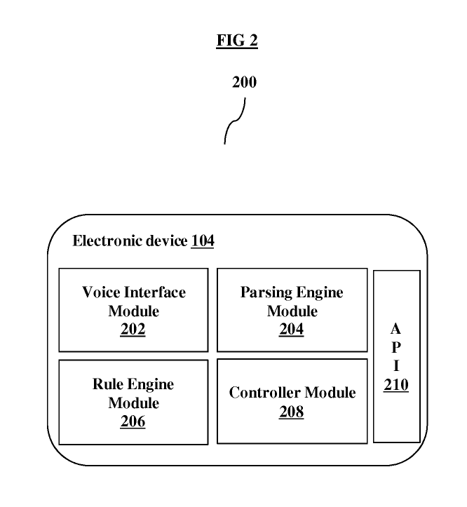

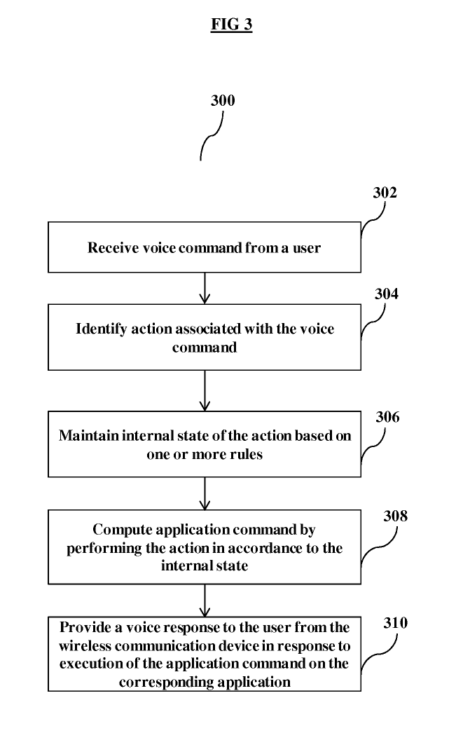

In an embodiment, the electronic device 104 can be configured to communicate with one or more remote sources 106 over a communication network. The communication network described herein can be for example, but not limited to, wireless network, wire line network, public network such as the Internet, private network, global system for mobile communication network (GSM), general packet radio network (GPRS), local area network (LAN), wide area network (WAN), metropolitan area network (MAN), cellular network, public switched telephone network (PSTN), personal area network, a combination thereof, or any other network. The remote sources 106 described herein can include for example but not limited to, web applications, remote electronic devices, enterprise software, individuals, and the like. The voice commands received from the user 102 includes the actions that need to be performed on the local or remote sources. The electronic device 104 includes the ability to run programs, also referred to as applications. The applications described herein can be resided on the electronic device 104 or on the remote sources 106. The electronic device 104 can be configured to communicate with the remote sources 106 forming a layer of communication interface to perform various actions on the remote sources 106. The layer of communication interface can also be used to receive the response from the remote sources 106. Further, the electronic device 104 can be configured to provide a voice response to the user 102 in response to execution of corresponding applications on the electronic device 104 or the remote sources 106. Furthermore, various operations performed by the system 100 are described in conjunction with the FIGS. 2 and 3.

The FIG. 1 shows a limited overview of the system 100 but, it is to be understood that another embodiment is not limited thereto. Further, the system 100 can include different modules communicating among each other along with other hardware or software components. For example, the component can be, but not limited to, a process running in the electronic device, an executable process, a thread of execution, a program, and/or a computer. By way of illustration, both an application running on an electronic device and the electronic device can be the component.

FIG. 2 illustrates different modules 200 present in the electronic device 104, according to embodiments as disclosed herein. In an embodiment, the electronic device 104 can be configured to include a voice interface module 202, parsing engine module 204, rule engine module 206, a controller module 208, and an Application Program Interface (API) 210. The voice interface module 202 can be configured to capture the voice commands recited by the user 102. The recited voice commands are recognized using, for example, any speech recognition technique known in the art. Further, the voice interface module 202 can be configured to convert the response received from the electronic device 104 or the remote sources 106 into voice response and verbally provide it to the user 102 such that the user can use the applications hands-free and eyes-free. The parsing engine module 204 can be configured to parse the captured voice command and identify the key nouns, verbs, objects, and linguistic relationships, syntaxes, and the like associated with the voice commands. In an embodiment, the parsing engine module 204 may operate in one language or in many languages simultaneously. Each voice command can include the actions to be performed on the applications available on the electronic device 104 or the remote source 106. The parsing engine module 204 can be configured parse the voice commands and identify the actions associated with the voice commands.

The rule engine module 206 can be configured to implement one or more rules and maintains one or more internal states of the actions in order to negotiate with the applications (in accordance to user commands) and accurately perform the actions throughout the system 100. Unlike conventional system, the internal states can be dynamically defined based on, for example, but not limited to, a response to the voice commands, and a response of execution of the actions. In an example, while playing a computer game, the internal states of the user level and ammunition status is dynamically maintained. While playing a game, the user may come across various monsters and the rule engine module 206 can execute the rules against the internal states and the ammunition status of the user. If the rule engine module 206 indicates that the user is lacking in ammunition to fight against a particular monster then a dynamic voice alert or voice message can be automatically provided to the user for not to fight against that monster.

The controller module 208 can be configured to compute one or more application commands by performing the actions in accordance to the internal states. The application command described herein includes an instruction that causes corresponding applications residing on the electronic device 104 or on any remote sources 106 to execute the application commands. For example, while playing a game, the controller module 208 can be configured to execute application commands on the game application to provide the voice response to the user in accordance to the internal states.

The controller module 208 can be configured to use the API 210 to communicate with various local and remote applications and provide voice responses to the user. The use of the two-way voice-enabled communication, by maintaining the internal states, offers a voice based experience to the users to use various applications hands-free and eyes-free. In an example, if the user voice commands indicate an action “Tell me tips to reduce headache” then the controller module 206 can create application commands to perform the action. The internal states of the action can be dynamically maintained as “tips to reduce” and “headache”. Note that the internal states can be dynamically changed in accordance to the response of execution of the actions, voice commands, and application commands. The controller module 206 can invoke an API call to the remote sources 106 (such as a doctor or any other remote source) to get “the tips to reduce headache”. In case, if the remote sources 106 provide tips related to the “stomachache” instead of “headache” then the rule engine module 206 runs the rules on the internal states and negotiates with the remote sources 106 to provide “tips related to reduction of “headache” instead of “stomachache”. After the response is received from the remote sources 106, the controller module 206 (in communications with the voice interface module 202) verbally provides the response to the user and accordingly the internal states can be dynamically updated. In yet another example, while playing the games, the internal state of the user and the game is dynamically maintained. If the user forgets to pick up content X from a particular place Y and trying to move to next level then the rule engine module 206 executes the rules on the internal states and provide a voice response to the user to pick the content X from the place Y before moving to the next level.

FIG. 3 illustrates a flow diagram illustrating a method 300 for enabling two-way voice communication using the electronic device 104, according to embodiments as disclosed herein. The method 300 and other description described herein provide a basis for a control program which can be implemented using a microcontroller, microprocessor, or an equivalent thereof. In an embodiment, at step 302, the method 300 includes receiving voice commands from the user 102. The user 102 may recite the voice commands indicating the actions to be performed on the electronic device 104 or the remote sources 106. In an example, the method 300 allows the voice interface module 202 to capture the voice commands recited by the user 102. At step 304, the method 300 includes identifying the actions associated with the voice commands. The method 300 allows the parsing engine module 204 to parse the voice commands to identify the actions associated with the voice commands.

At step 306, the method 300 includes maintaining internal states of the actions based on the one or more rules. Unlike conventional system, the internal states can be dynamically defined based on, for example, but not limited to, a response to the voice commands, and a response of execution of the actions. The method 300 allows the rule engine module 206 to maintain the internal states of the actions, such as to accurately perform the actions throughout the voice-enabled communication system. At step 308, the method 300 includes computing application commands by performing the action in accordance to the internal states. The application command can includes an instruction that causes corresponding applications residing on the electronic device or on any remote sources to execute the application commands. The method 300 allows the controller module 208 to compute the application commands by performing the actions in accordance to the internal states. The method 300 allows the controller module 208 to use the API 210 to execute the application commands on local and remote applications in accordance to the internal state. Note that the internal states can be dynamically changed in accordance to the response of execution of the actions, the voice commands, and the application commands on the corresponding applications. At step 310, the method 300 includes providing a voice response to the user from the electronic device in response to execution of the application command on the corresponding application. The method 300 allows the voice interface module 202 to composite the response received from the local or remote application into appropriate voice response to provide to the user. The use of such two-way voice-enabled communication, by maintaining the internal states, offers the voice based experience to the users to use various applications hands-free and eyes-free.

The various actions units, steps, blocks, and acts described in the method 300 may be performed in the order presented, in a different order, or simultaneously. Further, in some embodiments, some actions, units, steps, blocks, and acts listed in the FIG. 3 may be omitted, added, skipped, and modified without departing from the scope of the embodiment.

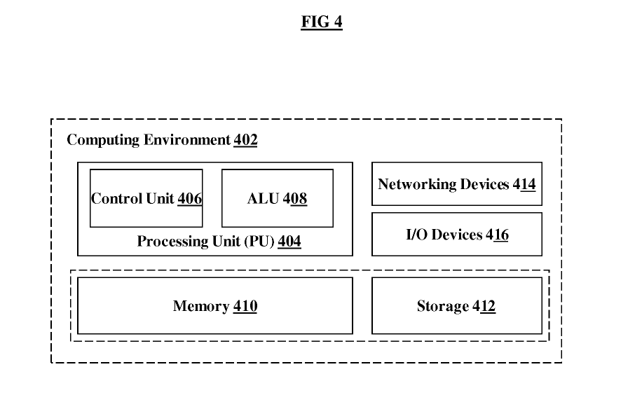

FIG. 4 illustrates a computing environment 402 implementing the method and systems, according to the embodiments as disclosed herein. As depicted the computing environment 402 comprises at least one processing unit 404 that is equipped with a control unit 406 and an Arithmetic Logic Unit (ALU) 408, a memory 410, a storage unit 412, plurality of networking devices 414 and a plurality Input output (I/O) devices 416. The processing unit 404 is responsible for processing the instructions of the algorithm. The processing unit 404 receives commands from the control unit 406 in order to perform its processing. Further, any logical and arithmetic operations involved in the execution of the instructions are computed with the help of the ALU 408.

The overall computing environment 402 can be composed of multiple homogeneous and/or heterogeneous cores, multiple CPUs of different kinds, special media and other accelerators. The processing unit 404 is responsible for processing the instructions of the algorithm. Further, the plurality of processing units 404 may be located on a single chip or over multiple chips.

The algorithm comprising of instructions and codes required for the implementation are stored in either the memory unit 410 or the storage 412 or both. At the time of execution, the instructions may be fetched from the corresponding memory 410 and/or storage 412, and executed by the processing unit 404. In case of any hardware implementations various networking devices 414 or external I/O devices 416 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 4 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for enabling two-way voice communication using an electronic device, the method comprising:
receiving at least one voice command from a user;
identifying at least one action associated with said at least one voice command;
maintaining at least one internal state of said at least one action based on at least one rule, wherein said internal state is dynamically defined based on a response to at least one of: said at least one voice command and said at least one action;
computing at least one application command by performing said at least one action in accordance to said at least one internal state; and
providing a voice response to said user from said electronic device in response to execution of said at least one application command on at least one corresponding application.

2. The method of claim 1, wherein said at least one corresponding application is on said electronic device.

3. The method of claim 1, wherein said at least one corresponding application is on at least one remote source.

4. The method of claim 1, wherein execution of said at least one application command further comprises:
invoking an application program interface (API) call from said electronic device to said at least one corresponding application;
allowing said corresponding application to execute said at least one application command; and
providing said voice response to said user from said electronic device in response to execution of said at least one application command.

5. A system for enabling two-way voice communication, the system comprising an electronic device configured to:
receive at least one voice command from a user,
identify at least one action associated with said at least one voice command,
maintain at least one internal state of said at least one action based on at least one rule, wherein said internal state is dynamically defined based on a response to at least one of: said at least one voice command and said at least one action,
compute at least one application command by performing said at least one action in accordance to said at least one internal state, and
provide a voice response to said user from said electronic device in response to execution of said at least one application command on at least one corresponding application.

6. The system of claim 5, wherein said at least one corresponding application is on said electronic device.

7. The system of claim 5, wherein said at least one corresponding application is on at least one remote source.

8. The system of claim 5, wherein execution of said at least one application command further comprises:
invoke an application program interface (API) call from said electronic device to said at least one corresponding application;
allow said corresponding application to execute said at least one application command, and
provide said voice response to said user from said electronic device in response to execution of said at least one application command.

9. A computer program product for enabling two-way voice communication using an electronic device, the product comprising:
an integrated circuit comprising at least one processor;
at least one memory having a computer program code within said circuit, wherein said at least one memory and said computer program code with said at least one processor cause said product to:
receive at least one voice command from a user,
identify at least one action associated with said at least one voice command,
maintain at least one internal state of said at least one action based on at least one rule, wherein said internal state is dynamically defined based on a response to at least one of: said at least one voice command and said at least one action,
compute at least one application command by performing said at least one action in accordance to said at least one internal state, and
provide a voice response to said user from said electronic device in response to execution of said at least one application command on at least one corresponding application.

10. The computer program product of claim 9, wherein said at least one corresponding application is on said electronic device.

11. The computer program product of claim 9, wherein said at least one corresponding application is on at least one remote source.

12. The computer program product of claim 9, wherein execution of said at least one application command further comprises:
invoke an application program interface (API) call from said electronic device to said at least one corresponding application;
allow said corresponding application to execute said at least one application command, and
provide said voice response to said user from said electronic device in response to execution of said at least one application command.
